(19) United States
(12) Patent Application Publication
(10) Pub. No.: US 2023/0316325 A1
(43) Pub. Date: Oct. 5, 2023

(54) GENERATION AND IMPLEMENTATION OF A CONFIGURABLE MEASUREMENT PLATFORM USING ARTIFICIAL INTELLIGENCE (AI) AND MACHINE LEARNING (ML) BASED TECHNIQUES

(71) Applicant: Meta Platforms, Inc., Menlo Park, CA (US)

(72) Inventors: Dmitry SMIRNOV, London (GB); Alessandro ZOLLA, Stratford upon Avon (GB); Marcus Voltis BULACH, London (GB); Amol SHARMA, London (GB); Carlos PEÑA BRAVO, London (GB); Attila SZILI, Watford (GB); Matthew WINN, London (GB)

(73) Assignee: Meta Platforms, Inc., Menlo Park, CA (US)

(21) Appl. No.: 17/707,518

(22) Filed: Mar. 29, 2022

(51) Int. Cl. G06Q 30/02; G06F 11/34; G06F 11/30

(52) U.S. Cl. CPC G06Q 30/0242; G06F 11/3065; G06F 11/3409; G06Q 30/0277

(57) ABSTRACT

According to examples, a system for using artificial intelligence (AI) and machine learning (ML) techniques to generate and implement a configurable measurement platform is described. The system may include a processor and a memory storing instructions. The processor, when executing the instructions, may cause the system to access information associated with one or more events occurring on a platform with event activity, log and analyze the one or more events to generate measurement data associated with the event activity, and generate a metric associated with the measurement data. The processor, when executing the instructions, may then generate a computed metric value associated with the metric utilizing the measurement data, implement a platform computation utilizing the computed metric value, and facilitate a decision associated with the platform based on the platform computation.

### TECHNICAL FIELD

This patent application relates generally to generation and delivery of content, and more specifically, to systems and methods for using artificial intelligence (AI) and machine learning (ML) techniques to generate and implement a configurable measurement platform.

### BACKGROUND

Advances in technologies associated with content management, creation, and distribution are enabling a proliferation of computer-implemented platforms. One example of such a computer-implemented platform may be a social media platform.

It may be appreciated that implementation of these platforms may generate large amounts of data associated with platform activity. In some examples, a provider may utilize this data to implement one or more objectives. In one such example, the provider may employ a computer-implemented model utilizing this data with an objective to minimize environmental impacts associated with the platform.

However, it may be appreciated that, in some examples, implementation of a platform utilizing this data may also present a number of issues. For example, utilizing data that may be incorrect or inapplicable may lead to decreased efficiencies and wasted resources.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a diagram of an implementation structure for a neural network (NN) implementing deep learning to generate and deliver related user interactions based on existing user interactions, according to an example.

FIG. 1B illustrates a block diagram of a resource stack associated with a content platform, according to an example.

FIG. 2A illustrates a block diagram of a system environment, including a system, that may be implemented to utilize artificial intelligence (AI) and machine learning (ML) techniques to generate and implement a configurable measurement platform, according to an example.

FIG. 2B illustrates a block diagram of the system that may be implemented to utilize artificial intelligence (AI) and machine learning (ML) techniques to generate and implement a configurable measurement platform, according to an example.

FIG. 2C illustrates a block diagram of a plurality of measurement platform components associated with a measurement platform, according to an example.

FIG. 3 illustrates a block diagram of a computer system to utilize artificial intelligence (AI) and machine learning (ML) techniques to generate and implement a configurable measurement platform, according to an example.

FIG. 4 illustrates a method for utilize artificial intelligence (AI) and machine learning (ML) techniques to generate and implement a configurable measurement platform, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

It should be appreciated that, as used herein, the terms “content,” “digital content item,” “content item,” and “digital item” may refer interchangeably to themselves or to portions thereof. Also, as used herein, a “user” may include any user of a computing device or digital content delivery mechanism who receives or interacts with delivered content items, which may be visual, non-visual, or a combination thereof.

Advances in technologies associated with content management, creation, and distribution are enabling a proliferation of computer-implemented platforms. One such type of platform may be a content platform, such as a social media platform, where users may exchange messages (i.e., text), digital images, and digital audio. As used herein, “content,” “digital content,” “digital content item” and “content item” may refer to any digital data (e.g., a data file). Examples such digital data include, but are not limited to, digital images, digital video files, digital audio files, and/or streaming content.

Typically, a content platform may be implemented according to one or more objectives. For example, in some instances, a content platform provider may operate a content platform with an objective to optimize delivery of content that may be of interest to users of the content platform. In another example, in some instances, a content platform provider may operate a content platform with an objective to minimize environmental impacts associated with the content platform.

In some instances, to facilitate these objectives, a content platform provider may need to implement associated decisions. For example, in some instances, a content platform provider may need to decide how many computer servers may be necessary to provide an enjoyable user experience for a user base of one (1) million users. It may be appreciated that, in some examples, a decision associated with a content platform may be taken by others as well. For example, in some examples, a user advertiser of the content platform may decide how a greatest number of interested users may be reached at a lowest possible expenditure.

In some examples, a content platform provider may provide one or more computer-implemented models (or “models”) to facilitate decision-making associated with a platform. In some examples, these models may be employed to, among other things, evaluate a hypothesis, test a projected outcome (i.e., determining an impact), make one or more adjustments, and implement one or more new objectives. In some instances, these processes may be referred to as “experimentation.”

It may be appreciated that one or more models may be applied with respect to a variety of aspects of a content platform. So, in a first example, a content platform provider may utilize a model to determine which content items to recommend to users. In a second example, a content platform provider may implement a model to enable an advertiser user to reliably and efficiently direct content to viewers that may be predisposed.

Examples of models that may be implemented to optimize these objectives and/or decisions include models that may implement aspects of neural networking, artificial intelligence, and machine learning (ML). In some examples and as described herein, a neural network (NN) that may be implemented may include one or more computing devices configured to implement one or more networked machine-learning (ML) algorithms to “learn” by progressively extracting higher-level information from input data. In some examples, the one or more networked machine-learning (ML) algorithms of a neural network (NN) may implement “deep learning.” A neural network (NN) implementing deep learning and artificial intelligence (AI) techniques may, in some examples, utilize one or more “layers” to dynamically transform input data into progressively more abstract and/or composite representations. These abstract and/or composite representations may be analyzed to determine hidden patterns and correlations and determine one or more relationships or association(s) within the input data. In addition, the one or more determined relationships or associations may be utilized to make predictions, such a likelihood that a user will be interested in a content item.

As discussed further below, the systems and methods described herein may utilize various neural network (NN) technologies. Examples of neural network (NN) mechanisms that may be employed may include an artificial neural network (ANN), a sparse neural network (SNN), a convolutional neural network (CNN), and a recurrent neural network (RNN). Additional examples of neural network mechanisms that may be employed may also include a long/short term memory (LSTM), a gated repeated unit (GRU), a Hopfield network, a Boltzmann machine, a deep belief network and a generative adversarial network (GAN).

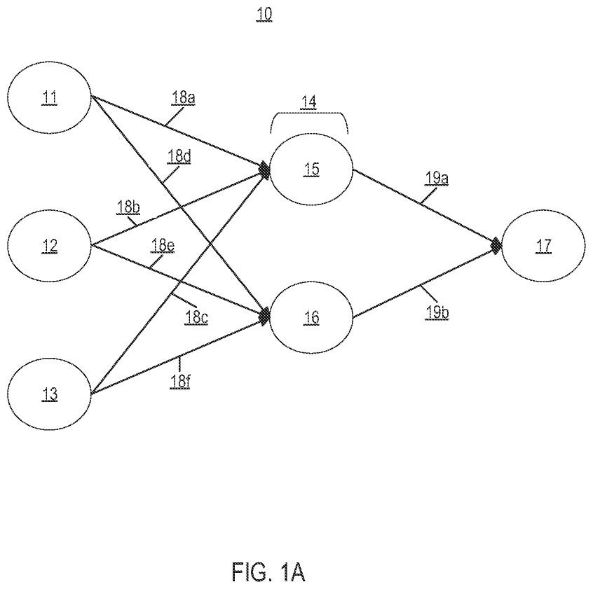

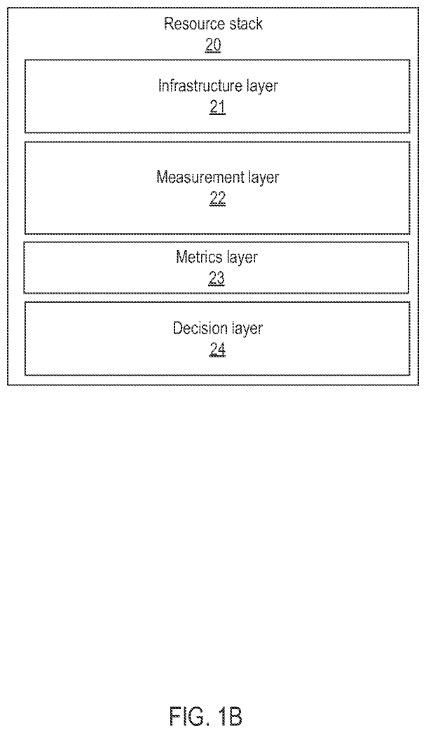

FIG. 1A illustrates a diagram of an implementation structure for a neural network (NN) implementing deep learning. In some examples, implementation of neural network 10 (hereinafter also referred to as “network 10”) may include organizing a structure of the network 10 and “training” the network 10.

In some examples, organizing the structure of the network 10 may include network elements including one or more inputs, one or more nodes and an output. In some examples, a structure of the network 10 may be defined to include a plurality of inputs 11, 12, 13, a layer 14 with a plurality of nodes 15, 16, and an output 17. In addition, in some examples, organizing the structure of the network 10 may include assigning one or more weights associated with the plurality of nodes 15, 16. In some examples, the network 10 may implement a first group of weights 18, including a first weight 18a between the input 11 and the node 15, a second weight 18b between the input 12 and the node 15, a third weight 18c between the input 13 and the node 15. In addition, the network 10 may implement a fourth weight 18d between the input 11 and the node 16, a fifth weight 18e between the input 12 and the node 16, and a sixth weight 18f between the input 13 and the node 16 as well. In addition, a second group of weights 19, including the first weight 19a between the node 15 and the output 17 and the second weight 19b between the node 16 and the output 17 may be implemented as well.

In some examples, “training” the network 10 may include utilization of one or more “training datasets” {(xᵢ, yᵢ)}, where i=1 . . . N for an N number of data pairs. In particular, as will be discussed below, the one or more training datasets {(xᵢ, yᵢ)} may be used to adjust weight values associated with the network 10.

Training of the network 10 may also include, in some examples, may also include implementation of forward propagation and backpropagation. Implementation of forward propagation and backpropagation may include enabling the network 10 to adjust aspects, such as weight values associated with nodes, by looking to past iterations and outputs. In some examples, a forward “sweep” through the network 10 to compute an output for each layer. At this point, in some examples, a difference (i.e., a “loss”) between an output of a final layer and a desired output may be “back-propagated” through previous layers by adjusting weight values associated with the nodes in order to minimize a difference between an estimated output from the network 10 (i.e., an “estimated output”) and an output the network 10 was meant to produce (i.e., a “ground truth”). In some examples, training of the network 10 may require numerous iterations, as the weights may be continually adjusted to minimize a difference between estimated output and an output the network 10 was meant to produce.

In some examples, once weights for the network 10 may be learned, the network 10 may be used make an “inference,” and/or determine a prediction loss. In some examples, the network 10 may make an inference for a data instance, x*, which may not have been included in the training datasets {(xᵢ, yᵢ)}, to provide an output value y* (i.e., an inference) associated with the data instance x*. Furthermore, in some examples, a prediction loss indicating a predictive quality (i.e., accuracy) of the network 10 may be ascertained by determining a “loss” representing a difference between the estimated output value y* and an associated ground truth value.

To support these models, in some examples, various data from an associated content platform may be utilized. In some examples, a content platform may gather this various data via one or more measurements. As used herein, the term “measurement” may be include any gathering of information (e.g., data) associated with an aspect of a content platform. In one example, a measurement associated with a content platform may be a number of petabytes of data (e.g., one and a half (1.5)) transferred in a day on the content platform.

In some examples, a measurement may be associated with one or more events (e.g., activity) on a content platform. So, in one example involving a social media platform, a measurement may be taken each time (i.e., instance) that a user may provide feedback (e.g., a like, a share, a comment, etc.) in association with a content item.

In addition, in some examples, a content platform may generate “derived” measurements as well. One example of such of derived measurement may be a relationship between a first measurement and a second measurement, such as a ratio of a number of likes and a number of shares for an associated content item.

Various measurements associated with a content platform may be stored (e.g., in a server) for use in implementation of one or more associated computer-implemented models. Moreover, it may be appreciated that in some examples, these measurements may be gathered from one or more content platforms that may be operated by one or more providers.

In some examples, one or more measurements may be associated with a metric. As used herein, a “metric” may be any representation of an aspect of a content platform. In some examples, these representations may take a form of a quantification, such as (a number of) shares associated with one or more content items or (a number of) petabytes of data transferred over the content platform per day. In addition, in some examples, these representations may take a form of a description, such as category or classification (e.g., of subject matter) associated with a content item. Also, in some examples, these representations may take a form of a designation, such as an indication of an appropriate viewing age for viewers. It may be appreciated that metrics may take any number of other forms as well.

In some examples, a metric may be implemented via use of a particular methodology or formula. For example, a metric such as “click-through rate” (CTR) for a content item may, in some instances, be defined as a ratio of users who engage (e.g., click on) a content item to the number of total users who view the content item. In some examples, the methodology or formula defining the metric may be defined by a user, such as a content platform provider. In some examples and as will be discussed further below, one or more metrics may be implemented and/or utilized by a computer-implemented model in association with implementation of a content platform.

In some examples, a metric may be associated with various “meta-information.” Examples of this meta-information may include information associated with its origin or past use (i.e., “lineage”), its creator and/or controller (i.e., “ownership”), information associated with how in which the metric may be applied, and a “lifetime” of the metric (i.e., a time period over which the metric should be utilized).

In some examples, a metric that may have sufficient information (or meta-information) may be referred to as a “healthy” metric. Conversely, in some examples, a metric may be designated as “unhealthy” if the metric may have insufficient associated information. It may be appreciated that, in some instances, an “unhealthy” metric (e.g., an “orphaned” metric having no origin information) may not display sufficient “fitness” for utilization in a model.

In some examples, each of these aspects (e.g., measurements, metrics, models, etc.) may be implemented via use of one or more layers in a resource stack. As used herein, a “resource stack” may include, among other things, one or more elements of computer hardware or software that may be utilized in association with implementation of a content platform.

FIG. 1B illustrates a block diagram of a resource stack 20 associated with a content platform, according to an example. In some examples, the resource stack 20 may include a plurality of layers 21-24. In some examples, a first layer of the resource stack 20 may be an infrastructure layer 21. In some examples, the infrastructure layer 21 may include one or more networked devices. Examples of these networked devices may be storage devices (e.g., databases), network devices (e.g., servers), sensors, user devices, etc.

In some examples, a second layer of the resource stack 20 may be a measurement layer 22. In some examples, the measurement layer 22 may include one or more software applications directed to gathering measurements associated with a content platform. It may be appreciated that implementing and/or managing a content platform may require managing a large number of associated measurements. In some examples, this may include (among other things) tracking, logging, and analyzing raw events associated with activity on the content platform.

In some examples, a third layer of the resource stack 20 may be a metrics layer 23. In some examples, the metrics layer 23 may generate information associated with one or metrics of a content platform. In particular, in some examples, the metrics layer 23 may implement one or more methodologies or formulas that, along with measurement data (e.g., as gathered by the measurement layer 22), may be utilized to generate one or more values associated with the one or more metrics.

In some examples, a fourth layer may be a decision layer 24. In some examples, the decision layer 24 may enable one or more decisions. In some examples, these one or more decisions may be related one or more objectives associated with the content platform. Also, in some examples, the decision layer 24 may enable implementation of one or more computer-implemented models to analyze various information associated with a content platform (e.g., one or more metrics generated by the metrics layer 23).

It may be appreciated that, in some examples, implementation of a content platform may present a number of issues. In some instances, these various issues may lead to decreased efficiencies and wasted resources. Various examples of these issues are discussed further below.

In some examples, one issue may be associated with implementation of a number of “unused” or “under-utilized” (e.g., outdated) metrics. In some instances, these unused or under-utilized metrics may be computed each time a computer model may be implemented, even though their computation may not be necessary or beneficial.

In some examples, another issue may be associated with an excessive number of “unhealthy” metrics. For example, in some instances, a metric may be said to be unhealthy if there may not be sufficient information (or meta-information) regarding how the metric may be computed. In another example, a metric may be said to be unhealthy if its ownership and lineage may be unclear. It yet another example, a metric may be said to be unhealthy if it may not be clear how the metric is to be implemented. In some instances, these unhealthy metrics may prevent effective experimentation and may lead to incorrect decisions.

In some examples, a content platform may implement metrics in a manner that may not adequately protect privacy. For example, in some instances, a content platform may not properly categorize or contextualize a metric. As a result, the content platform may be susceptible to unnecessary or unwanted leakage of associated measurements (i.e., data). Also, in some examples, improper “ownership” or “lineage” of a metric may lead to a risk associated with (e.g., user) privacy as well.

In some examples, it may not be apparent that a metric may be unhealthy. In these instances, this may result in incorrect metrics being utilized, which may further result in incorrect decisions based on the incorrect metrics.

In some examples, a content platform may not provide appropriate uniformity or customization(s) with regard to application or use of a metric. So, in some examples indicating a lack of uniformity, a first computational element (e.g., a first model) may utilize a different name or methodology for a metric than a second computational element (e.g., a second model). Conversely, in some examples indicating a lack of customization where more particularized application may be appropriate, a first computational element of a content platform may be unable to offer use of a different name or methodology than a second computational element.

In some examples, a content platform may not enable users to evaluate a “suitability” of a particular metric (e.g., with respect to a particular context). In particular, in some examples, it may be difficult to determine whether an existing metric should be implemented or whether a new metric should be created.

In addition, in some examples, it may be difficult to correct data processing associated with a metric. In some examples, upon incorrect processing of data associated with a metric, a “backfill” process may be employed. In some examples, a backfill process may enable a recalculating and/or re-purposing of the data. In some instances, existing implementations may not efficiently implement backfill operations.

In some examples, a content platform may offer an inefficient “workflow” associated with creation and implementation of metrics. For example, in some instances, it may be difficult to change aspects of an application or scope of an existing metric. In addition, in some examples, creation of a new metric that may comply with applicable privacy conditions and use conditions (i.e., “guardrails”) may often be inefficient.

Furthermore, in some examples, an unhealthy metric may have an associated “blast radius.” That is, in some examples, a first, unhealthy metric of a content platform may cause an (unwanted) impact associated with a second metric. It may be appreciated that such a blast radius may lead to one or more of misleading representations (e.g., modeling results), incorrect decisions, and wasted resources.

Systems and methods described may provide for implementation of a configurable measurement platform using machine learning (ML) and artificial intelligence (AI) techniques. In some examples, the systems and methods may provide a measurement platform that may enable generation and implementation of one or more healthy metrics, adjustable privacy controls, and additional developer and workflow efficiencies.

In some examples, the systems and methods may receive and process incoming platform data based on event activity associated with one or more platforms and process the incoming platform data to generate one or more measurements associated with the one or more platforms. In addition, the systems and methods may generate one or more metrics with the one or more generated measurements, implement one or more models in association with the one or more generated metrics, and facilitate a decision (i.e., an action) in association with a result of the one or more models. It may be appreciated that, while the features, systems, and methods described herein may primarily be associated with content platforms, these features, systems, and methods may be implemented in association with any type of platform that may employ measurements and/or metrics to implement associated decision-making.

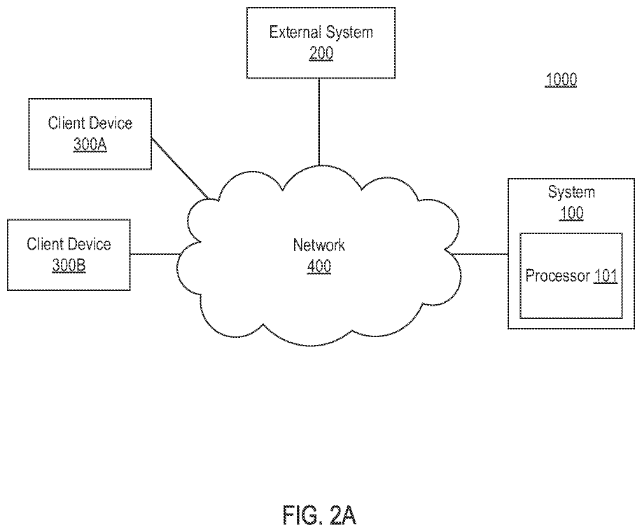

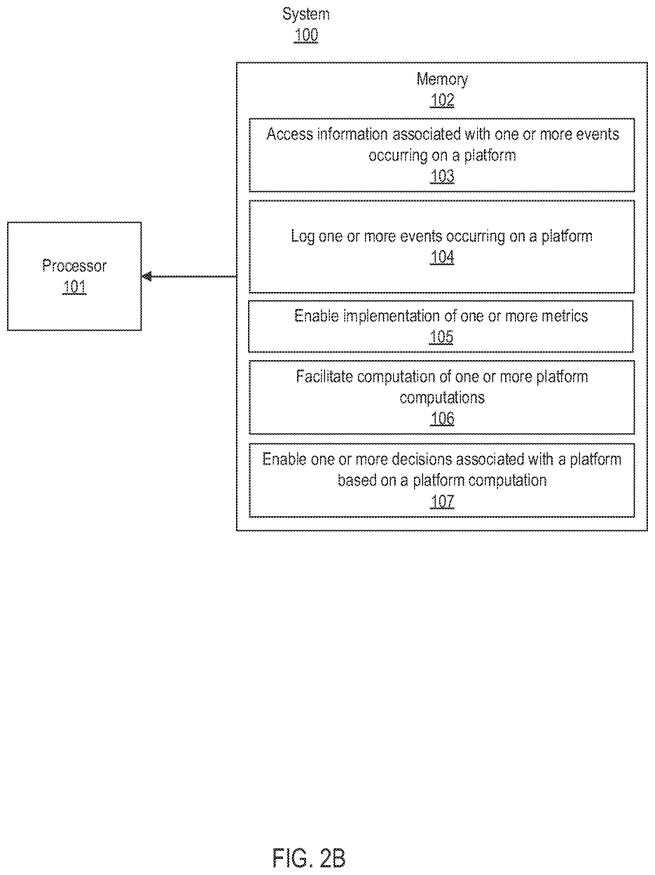

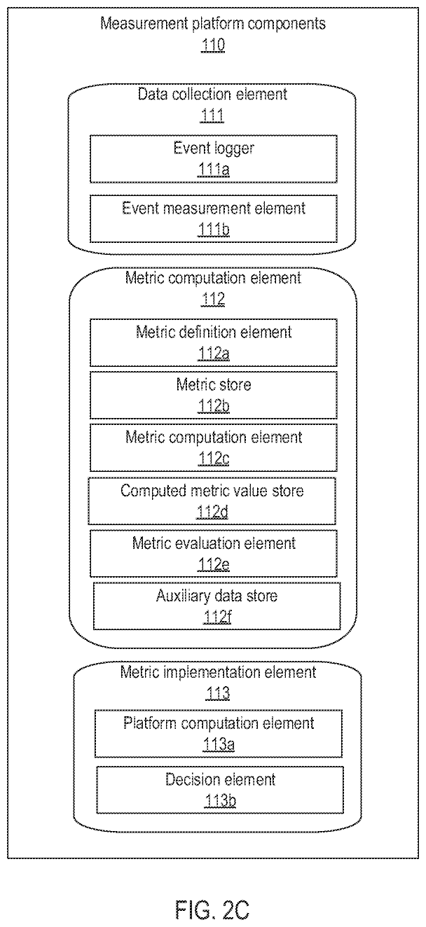

In some examples, the system and methods may be configured to adjustably provide developer and operational efficiencies. It may be appreciated that. in some examples, the systems and methods may implement various features in association with an infrastructure layer, a measurement layer, a metrics layer, and/or a decision layer as described above. In particular, in some examples, the systems and methods may be configured to provide an adjustable, effective interfacing between an infrastructure layer (e.g., the infrastructure layer 21 of FIG. 2), a measurement layer (e.g., the measurement layer 22 of FIG. 2), and a metrics layer (e.g., the metrics layer 23 of FIG. 2).

In some examples, the systems and methods may enable developers to introduce new metrics, remove existing metrics (e.g., unused metrics, underutilized metrics, redundant metrics, etc.), and enable associated recovery mechanisms. Accordingly, in some examples, the systems and methods may be configured to reduce (modeling) cycle times and to provide enhanced (i.e., more efficient) development protocols.

In some examples, where it may not be apparent that a metric may be unhealthy, the systems and methods may provide features and tools that may enable to define and/or describe one or more metrics. In defining and/or describing a metric, the systems and methods may implement one or more validations that may need to be performed to ensure that the metric may be healthy.

In some examples, the systems and methods may provide governance in association with measurements and metrics of a platform. As used herein, “governance” may include implementation of one or more protocols that may be utilized to facilitate (among other things) creation, ownership (e.g., requirements), use (e.g., health checks) of a metric.

In some examples, governance may be provided via implementation of various meta-information. Examples of such meta-information may include information associated with origin or previous use (i.e., “lineage”) of a metric and information associated with one or more creators or users of a metric. Additional examples of such meta-information may include information associated with how the metric may be applied (e.g., a context) and a “lifetime” of the metric (i.e., a time period over which the metric should be utilized).

In addition, in some examples, governance may be provided via implementation of various protocols. Examples of such protocols may include protocols that may allow or limit use of a metric (e.g., based on a context or experiment), or protocols that may limit a lifetime of use for a metric. Accordingly, in some examples, these various protocols may enable particular and/or customized implementations of a metric.

In some examples, the systems and methods may provide discoverability associated with one or more metrics. As used herein, “discoverability” may refer to one or more features that may enable a user to identify a metric. In addition, in some examples, the systems and methods may provide discoverability by enabling determining of which metric may be right (i.e., applicable) for a given use case.

In some examples, the systems and methods may evaluate various aspects of a metric (e.g., ownership, lineage, fitness, etc.) to provide one or more classification approaches that may be used to classify if a metric may be “healthy,” and/or if a metric may be “trusted” (i.e., verified). As a result, in some examples, the systems and methods may enable an evaluation of suitability of a metric for a given use case.

In some examples, the systems and methods may be configured to provide one or more adjustable privacy controls. In particular, in some examples, the systems and methods may be configured to implement one or more privacy controls that may be adjustable. For example, the privacy controls may be adjustable according to context or application, and/or may be adjustable according to user.

In some examples, in processing of associated metrics, the systems and methods may enable partitioning of data according to one or more privacy controls associated with a platform “opt-in” policy. That is, in some examples, the systems and methods may enable processing (e.g., aggregation) of metrics using measurement data associated with users that may have exercised an “opt-in,” while not using (i.e., separating) metrics that may use measurement data associated with users that may not have exercised the “opt-in.” Moreover, in some examples, the systems and methods may be configured to provide, among other things, established access control lists (ACL) and lineage documentation as well.

In some examples, to provide a configurable measurement platform, the systems and methods may implement a domain-specific language (DSL). As used herein, a domain specific language (DSL) may refer to, among other things, a computer language directed to a particular application domain (i.e., an adaptable measurement platform). In some examples and as will be discussed further, the systems and methods may utilize a domain-specific language (DSL) to implement one or more objectives and features associated with an adaptable measurement platform described herein. In some examples, the domain specific language (DSL) used to describe and/or define a metric may enable a description of one or more validations that may be performed to ensure that the metric may be healthy.

In some examples, by implementing a domain-specific language (DSL) for an adaptable measurement platform, the systems and methods may enable a more “genericized,” and flexible approach to addressing the objectives and features described herein. In some examples, by utilizing the domain-specific language (DSL) for an adaptable measurement platform, the systems and methods may enable creation and use of a particular protocol directed to introduction (i.e., defining) of one or more metrics.

In some examples, by utilizing the domain-specific language (DSL) for an adaptable measurement platform, the systems and methods may enable a particular manner of computation for one or more metrics. Furthermore, in some examples, the systems and methods may implement protocols associated with defining and modifying receipt and analysis (e.g., measurement) of platform event activity, implementation of ownership and attribution of new and existing metrics, and implementation of checks and permissions (i.e., privacy) of new and existing metrics as well.

Accordingly, in general, by implementing the domain-specific language (DSL) for an adaptable measurement platform, the systems and methods may offer a variety of genericized, flexible, and particular features directed to, among other things, receiving and processing incoming platform data based on event activity associated with one or more platforms, and also processing the incoming platform data to generate one or more measurements associated with the one or more platforms. In addition, by implementing the domain-specific language (DSL) for an adaptable measurement platform, the systems and methods may implement features directed to generating one or more metrics with the one or more generated measurements, and also implement one or more models in association with the one or more generated metrics, and facilitate a decision in association with a result of the one or more models.

Moreover, in some examples, the systems and methods described may enable a “centralized,” and “pipelined” approach to implementation of a measurement platform. Unlike implementations wherein event measurement, implementation (e.g., creation, computation) of one or more metrics, and implementation of a platform computation may occur separately (and may require separate computations), the systems and methods described may enable efficient computational operation by associating event measurement, implementation of one or more metrics, and implementation of a platform computation into a consolidated approach implemented via use of, in part and among other things, a domain-specific language (DSL). Accordingly, in some examples, the systems and methods may provide enhanced usability and scalability for an associated measurement platform.

Reference is now made to FIGS. 2A-2C. FIGS. 2A-2C illustrate various aspects of a system environment, including a system, that may be implemented to use artificial intelligence (AI) techniques to generate and implement a configurable measurement platform. In particular, FIG. 2A illustrates a block diagram of a system environment, including a system, that may be implemented to utilize artificial intelligence (AI) and machine learning (ML) techniques to generate and implement a configurable measurement platform, according to an example. FIG. 2B illustrates a block diagram of the system that may be implemented to utilize artificial intelligence (AI) and machine learning (ML) techniques to generate and implement a configurable measurement platform, according to an example. FIG. 2C illustrates a block diagram of a plurality of measurement platform components associated with a measurement platform, according to an example.

As will be described in the examples below, one or more of system 100, external system 200, user devices 300A-300B and system environment 1000 shown in FIGS. 2A-2B may be operated by a service provider to utilize artificial intelligence (AI) and machine learning (ML) techniques to generate and implement a configurable measurement platform. It should be appreciated that one or more of the system 100, the external system 200, the user devices 300A-300B and the system environment 1000 depicted in FIGS. 2A-2B may be provided as examples. Thus, one or more of the system 100, the external system 200 the user devices 300A-300B and the system environment 1000 may or may not include additional features and some of the features described herein may be removed and/or modified without departing from the scopes of the system 100, the external system 200, the user devices 300A-300B and the system environment 1000 outlined herein. Moreover, in some examples, the system 100, the external system 200, and/or the user devices 300A-300B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 2A-2C may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to generation and delivery of content (e.g., platform information, etc.). As will be discussed further below, in other examples, the external system 200 may be utilized by a service provider (e.g., a social media application provider) as part of a data storage, wherein a service provider may access data on the external system 200 to generate and implement a configurable measurement platform.

In some examples, the user devices 300A-300B may be electronic or computing devices configured to transmit and/or receive data. In this regard, each of the user devices 300A-300B may be any device having computer functionality, such as a television, a radio, a smartphone, a tablet, a laptop, a watch, a desktop, a server, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the system 100 via the network 400.

Moreover, in some examples and as will also be discussed further below, the user devices 300A-300B may be utilized by a user viewing content (e.g., content on a social media application) distributed by a content platform provider, wherein information relating to the user may be stored and transmitted by the user devices 300A to other devices, such as the external system 200. In some examples, and as will described further below, a user may utilize the user device 300A to receive a content item associated with a content platform. Also, in some examples, by a user utilizing the user device 300B may utilize the user device 300B to provide feedback (e.g., a comment) associated with the content item associated with the content platform as well.

The system environment 1000 may also include the network 400. In operation, one or more of the system 100, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-300B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 2A, it should be appreciated that, in some examples, the network 400 may include a plurality of interconnected networks as well.

In some examples, and as will be discussed further below, the system 100 may be configured to utilize artificial intelligence (AI) and machine learning (ML) techniques to generate and implement a configurable measurement platform. Details of the system 100 and its operation within the system environment 1000 will be described in more detail below.

As shown in FIGS. 2A-2B, the system 100 may include processor 101 and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 2A-2B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-300B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-300B.

In some examples, the memory 102 may store instructions, which when executed by the processor 101, may cause the processor to: access 103 information associated with one or more events occurring on a platform; log 104 one or more events occurring on a platform; enable 105 implementation of one or more metrics; facilitate 106 computation of one or more platform computations; and facilitate 107 one or more decisions associated with a platform based on a platform computation.

In some examples, and as discussed further below, the instructions 103-108 on the memory 102 may be executed alone or in combination by the processor 101 to utilize artificial intelligence (AI) and machine learning (ML) techniques to generate and implement a configurable measurement platform. In some examples, the instructions 103-108 may be implemented in association with a content platform configured to provide content for users, while in other examples, the instructions 103-108 may be implemented as part of a stand-alone application.

It may be appreciated that, in some examples, to enable a computation utilizing the computed metric, the instructions 103-107 may implement a domain-specific language (DSL) directed an adaptable measurement platform. Furthermore, it may be appreciated that implementation of the domain-specific language (DSL) may enable a streamlined approach (i.e., “pipelined”) approach between event collection operations (e.g., as performed by the instructions 104), metric implementation operations (e.g., as performed by the instructions 105), aggregation operations (e.g., as performed by the instructions 106), and decision operations (e.g., as performed by the instructions 107).

In some examples and as will discussed further below, the instructions 103-107 may implement the plurality of measurement platform components 110 as illustrated in FIG. 2C. In some examples, the plurality of measurement platform components 110 may include a plurality of component elements 111-113.

Additionally, and as described above, although not depicted, it should be appreciated that to provide generation and delivery of content, instructions 103-107 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches, such as reinforcement learning, feature learning, anomaly detection, etc.

In some examples, the instructions 103 may access information associated with one or more events occurring on a platform. For example, in the case of a content platform such as a social media platform, the instructions 103 may access one or more types of event data associated with user activity on the content platform. Examples of such events may include views, likes, comments and shares.

In some examples, the instructions 104 may log (i.e., collect) one or more events occurring on a platform. In some examples, to log the event data, the instructions 104 may provide a data collection element 111 having an event logger 111a as illustrated in FIG. 2C. In particular, in some examples, the event logger 111a may log a first event by associating the first event with a first event type, and may log a second event by associating the second event with a second event type.

Also, in some examples, the instructions 104 may analyze one or more events to generate measurement data. In some examples, to analyze the one or more events, the instructions 104 may provide an event measurement element 111b in the data collection element 111 as illustrated in FIG. 2C. In some examples, the event measurement element 111b may analyze the one or more of the events to generate one or more measurements (i.e., measurement data). In some examples, the event measurement element 111b may measure events for an event type via implementation of a (sequential) count.

In some examples, the instructions 105 may enable implementation of one or more metrics. In some examples, implementation of one or more metrics via the instructions 105 may include (among other things) creation, ownership, use, and modification of the one or more metrics.

In some examples, the instructions 105 may enable a “federated” approach to creation, computation, use and/or modification of one or more metrics by structuring ownership of the one or more metrics. That is, in some examples, the instructions 105 may variously implement the one or more metrics based on a user, a circumstance and/or a setting. So, in some examples, the instructions 105 may provide a first user authority to create a metric (e.g., including providing a computational formula for the metric), while a second user may not be provided authority to create a metric but may be provided authority to modify an aspect of the metric (e.g., modifying the computation formula for the metric). In some examples, the instructions 105 may enable actions associated with a metric (e.g., creation, modification, etc.) to be tracked to ensure specified implementation.

In some examples, the instructions 105 may enable implementation of one or more metrics according to one or more protocols. In particular, in some examples, the instructions 105 may enable implementation of “governance” in association with the one or more metrics. In some examples, these one or more (established) protocols may enable and/or facilitate creation (i.e., system-defined or user-defined), computation, ownership (e.g., requirements), use (e.g., health checks, guardrails, etc.), and modification of the one or more metrics.

In some examples, the instructions 105 may enable implementation of various protocols that may provide or limit contextual use of a metric (e.g., based on a circumstance, setting, or experiment), or that may limit temporal use of a metric (e.g., provide a usage lifetime for a metric). For example, in some instances, the systems and methods may enable a second user to access and/or modify a first metric created by a first user, while in other instances, the systems and methods may prevent the second user from accessing and/or modifying a second metric created by the first user.

In addition, in some examples, the instructions 105 may enable implementation of various protocols that may enable various privacy controls. In particular, in some examples, the instructions 105 may enable partitioning of data according to one or more privacy controls. That is, in some examples, the instructions 105 may enable processing (e.g., aggregation) of metrics using measurement data associated with users that may have exercised an “opt-in” policy (i.e., option), while not using (i.e., separating) metrics that may use measurement data associated with users that may not have exercised the “opt-in” policy. Moreover, in some examples, the instructions 105 may be configured to provide, among other things, specified access control lists (ACL) and lineage documentation as well.

In some examples, the instructions 105 may enable association of various meta-information with a metric. Examples of this meta-information may specify and/or may provide information associated with origin, ownership or previous use (i.e., “lineage”) of a metric, information associated with one or more creators or users of a metric, information associated with how the metric may be applied (e.g., a context), and a “lifetime” of the metric (i.e., a time period over which the metric should be utilized). In addition, in some examples, the instructions 105 may provide meta-information that may include information associated with privacy, such as information related to privacy concerns in particular settings, circumstances, and use cases.

In some examples, the instructions 105 may provide protocols that may enable provide enhanced discoverability associated with one or more metrics. In particular, in some examples, the instructions 105 may enable determination (e.g., by a user) of a metric that may be appropriate for a particular setting, circumstance, or use case. In some examples, the instructions 105 may utilize various meta-information to provide the enhanced discoverability. Also, in some examples, the instructions 105 may provide various associated features to enhance discoverability, such as search and look-up features as well.

In some examples, the instructions 105 may implement one or more protocols that may provide status information associated with one or more metrics. In some examples, this status information may take the form of a “health check” that may be implemented by the instructions 105 to indicate if a metric may be “healthy,” and/or trusted. In some examples, the instructions 105 may utilize these aspects (e.g., status information, discoverability features, etc.) to enable a user to determine a suitability of a metric for a given use case or setting.

In some examples, to provide status information for a metric, the instructions 105 may evaluate various aspects of the metric (e.g., ownership, lineage, fitness, etc.) to provide one or more classifications. In some examples, the instructions 105 may indicate that a first metric may be trusted by associating a first classification (e.g., a green color). In some examples, the instructions 105 may indicate that a second metric should be given limited trust by associating a second classification (e.g., an amber color). Also, in some examples, the instructions 105 may indicate that a third metric should not be trusted by associating a third classification (e.g., a red color). In some instances, such a classification arrangement may be referred to as “RAG” (i.e., red, amber green) color scheme. As a result, in some examples, the instructions 105 may enable determination of “fitness” of a metric (e.g., for a particular setting or use case), and may limit use of metrics that should not be trusted (e.g., orphaned metrics).

Moreover, in some examples, the instructions 105 may be configured to minimize or mitigate a “blast radius” associated with a metric. In particular, in some examples, the instructions 105 may ensure that a failure in association with a first metric may only affect a dependent operation or experiment, and that it may not indiscriminately affect other operations or experiments.

In some examples, to implement one or metrics, the instructions 105 may provide a metric computation element 112 as illustrated in FIG. 2C. In some examples, the metric computation element 112 may include a metric definition element 112a, a metric store 112b, a metric computation element 112c, a computed metric value store 112d, and an auxiliary data store 112e.

In some examples, to enable creation of one or more metrics, the instructions 105 may implement a metric definition element 112a. In some examples, the metric definition element 112a may enable generation (i.e., creation) of a metric by a user having appropriate access. In addition, in some examples, the metric definition element 112a may enable establishing one or more protocols in association with the metric.

In some examples, the metric definition element 112a may enable implementation of a computation (e.g., a formula or methodology) associated with the metric. In addition, in some examples, the metrics definition element 112a may enable specifying of a weighting spectrum associated with the metric, which may be used to weight the metric during application in one or more models. Accordingly, in some examples, the metric definition element 112a may enable enhance efficiently associated workflows related to metric creation and definition, and may enable implementation applicable guardrails to ensure specified use.

In some examples, the instructions 105 may implement a metric store 112b (i.e., a “metric repository”). In some examples, upon creation of a metric, the instructions 105 may store the metric in the metric store 112b. In some examples, the metric store may be accessed to enable viewing, modification, and removal of a metric (e.g., by a user having appropriate access).

In some examples, the instructions 105 may provide and implement a metric computation element 112c. In particular, in some examples, the metric computation element 112c may access logged event data (e.g., via the instructions 104), and may utilize the logged event data to generate (i.e., compute) a computed metric value for the metric. As used herein, a “computed metric value” may include any value that may be computed in association with a metric implemented by the instructions 105. So, in one example, where the metric may be a click-through rate (CTR), the instructions 105 may compute that a particular content item may have a click-through rate (CTR) of nineteen percent (19%) (i.e., the computed metric value).

In some examples, the instructions 105 may provide a computed metric value store 112d to store a computed metric value associated with a metric. In some examples, the computed metric store 112d may be accessed, for example, to enable use of the computed metric value in one or more computer-implemented models.

In some examples, the instructions 105 may provide a metric evaluation element 112e to evaluate a status of a metric. In some examples, the instructions 105 (e.g., via the metric evaluation element 112e) may conduct a “health check” in association with the metric. In some examples, the metric evaluation element 120e may evaluate the status of the metric, and may provide an associated classification (e.g., using a red, amber, green (RAG) color scheme). In some examples, by (continuously) evaluating a status of one or more metrics, the instructions 105 may enable rapid implementation of recovery processes, such as a backfill operation, upon determining that a metric may be unhealthy or incorrectly specified.

In some examples, to generate a computed metric value, the instructions 105 may perform one or more database operations. Examples of these database operations include external (database) join operations and/or one or more internal (database) join operations, wherein the instructions 105 may join measurement data with auxiliary data to generate the computed metric. In addition, in some examples, to generate a computed metric value, the instructions 105 may perform various data compaction and/or data compression operations as well.

In some examples, the instructions 105 may provide auxiliary data store 120f. In some examples, the auxiliary data store 120f may access and/or utilize associated auxiliary data that may be necessary to generate a computed metric value. Examples of this auxiliary data may include, among other things, infrastructure-related data such as a type of hardware on which a model may have been serving user traffic. In some examples, this information may enable comparison of model performance for different hardware types. It may be appreciated that instructions 105 may access this auxiliary data from an external data store (e.g., the external system 200).

In some examples, the instructions 106 may facilitate computation of one or more platform computations. As used herein, an “platform computation” may include any computation in association with a platform that may implement a computed metric value. In some instances, the platform computation may also be referred to as “aggregation.”

In some examples, the instructions 106 may facilitate implementation of one or more computer-implemented models via use of one or more computed metric values (e.g., via the instructions 105). For example, in some instances, the instructions 106 may utilize one or more computed metrics to implement a model to determine which content items to recommend to users. In a second example, the instructions 105 may implement a model to enable an advertiser user to reliably and efficiently direct (advertising) content to viewers that may be predisposed.

In some examples, to facilitate a platform computation, the instructions 106 may be configured to implement a platform computation element 113a as shown in FIG. 2C. In some examples, the platform computation element 113a may be included in a metric implementation element 113 of the plurality of measurement platform components 110.

In some examples, the instructions 106 may facilitate implementation of a platform computation associated with a metric in a manner similar to the implementation of one or more metrics (e.g., as provided by the instructions 105). For example, in some instances, the instructions 106 may implement a platform computation associated with a metric. In addition, in some examples, the instructions 106 may provide implementation of a “governance” associated with implementation of a platform computation, and may enable association of various meta-information with implementation of a platform computation as well. Also, in some examples, the instructions 106 may implementation and/or modification of status information associated with one or more metrics based on implementation of a platform computation as well.

In some examples, the instructions 107 may facilitate one or more decisions (i.e., actions) associated with a platform based on a platform computation associated with a metric. As used herein, a “decision” associated with a platform may include any action taken based on measurement and/or metric associated with the platform.

In some examples where a content platform provider may implement a model to determine which content items to recommend to users, the instructions 107 (e.g., via the decision element 113b) may enable the content platform to deliver a content item to a particular user according to results of the model. Also, in an example where an advertiser may utilize a model (e.g., provided by a content platform provider) to determine users that may be predisposed to their (advertising) content, the instructions 107 may enable the content platform to deliver the content to a particular user.

In some examples, to enable one or more decisions associated with a platform, the instructions 107 may be configured to implement a decision element 113b as shown in FIG. 2C. In some examples, the decision element 113b may be included in a metric implementation element 113 of the plurality of measurement platform components 110.

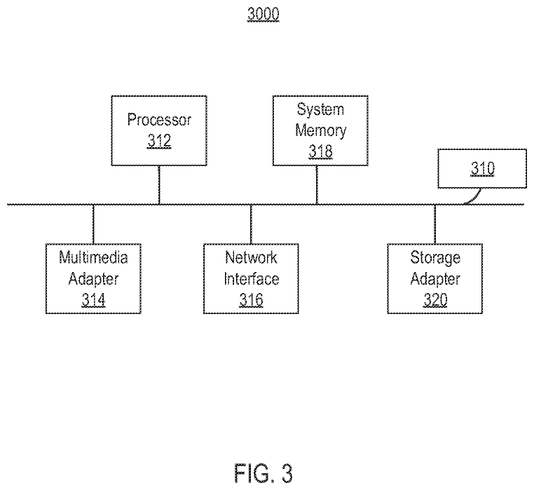

FIG. 3 illustrates a block diagram of a computer system to utilize artificial intelligence (AI) and machine learning (ML) techniques to generate and implement a configurable measurement platform, according to an example. In some examples, the system 3000 may be associated the system 100 to perform the functions and features described herein. The system 3000 may include, among other things, an interconnect 310, a processor 312, a multimedia adapter 314, a network interface 316, a system memory 318, and a storage adapter 320.

The interconnect 310 may interconnect various subsystems, elements, and/or components of the external system 300. As shown, the interconnect 310 may be an abstraction that may represent any one or more separate physical buses, point-to-point connections, or both, connected by appropriate bridges, adapters, or controllers. In some examples, the interconnect 310 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 310 may allow data communication between the processor 312 and system memory 318, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 312 may be the central processing unit (CPU) of the computing device and may control overall operation of the computing device. In some examples, the processor 312 may accomplish this by executing software or firmware stored in system memory 318 or other data via the storage adapter 320. The processor 312 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 314 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 316 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 316 may provide a direct or indirect connection from one network element to another, and facilitate communication and between various network elements.

The storage adapter 320 may connect to a standard computer-readable medium for storage and/or retrieval of information, such as a fixed disk drive (internal or external).

Many other devices, components, elements, or subsystems (not shown) may be connected in a similar manner to the interconnect 310 or via a network (e.g., network 400 of FIG. 1A). Conversely, all of the devices shown in FIG. 3 need not be present to practice the present disclosure. The devices and subsystems can be interconnected in different ways from that shown in FIG. 3. Code to implement the dynamic approaches for payment gateway selection and payment transaction processing of the present disclosure may be stored in computer-readable storage media such as one or more of system memory 318 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, 10S, ANDROID, UNIX, Linux, or another operating system.

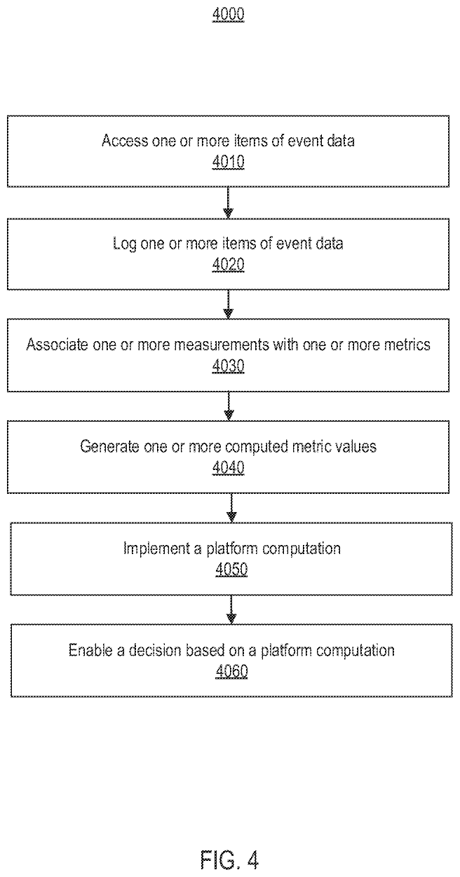

FIG. 4 illustrates a method for utilize artificial intelligence (AI) and machine learning (ML) techniques to generate and implement a configurable measurement platform, according to an example. The method 4000 is provided by way of example, as there may be a variety of ways to carry out the method described herein. Each block shown in FIG. 4 may further represent one or more processes, methods, or subroutines, and one or more of the blocks may include machine-readable instructions stored on a non-transitory computer-readable medium and executed by a processor or other type of processing circuit to perform one or more operations described herein.

Although the method 4000 is primarily described as being performed by system 100 as shown in FIGS. 2A-2B, the method 4000 may be executed or otherwise performed by other systems, or a combination of systems. It should be appreciated that, in some examples, to generate audio and video content based on text content, the method 4000 may be configured to incorporate artificial intelligence (AI) or deep learning techniques, as described above. It should also be appreciated that, in some examples, the method 4000 may be implemented in conjunction with a content platform (e.g., a social media platform) to generate and deliver content.

Reference is now made with respect to FIG. 4. In some examples, at 4010, the processor 101 may access one or more items of event data associated with a platform (e.g., a content platform).

In some examples, at 4020, the processor 101 may log one or more items of event data. In some examples, logging the one or more item of event data may include analyzing the one or more items of event data to generate measurement data including one or more measurements. So, in one example, the processor 101 may maintain a “count” of events associated with a particular event data type.

In some examples, at 4030, the processor 101 may associate one or more measurements with one or more metrics. In some examples, the processor 101 may enable creation of the one or more metrics via specification of one or more methodologies, protocols, and/or formulas. Furthermore, in some examples, the processor 101 may enable association and modification of various information (e.g., ownership information, usage information, etc.) with the one or more metrics.

In some examples, at 4040, the processor 101 may generate one or more computed metric values utilizing one or more measurements (e.g., gathered at 4020) and one or more metrics (e.g., associated at 4030).

In some examples, at 4050, the processor 101 may implement a platform computation associated with a metric. For example, in some instances, the processor 101 may facilitate implementation of one or more models via use of one or more computed metrics.

In some examples, at 4060, the processor 101 may enable one or more decisions (i.e., actions) based on a platform computation associated with a metric. In some examples, to enable the one or more decisions, the processor 101 may present results of one or more platform computations to a user, and may facilitate a decision by the user accordingly.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300A-300B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300, or shared with other systems. Although this disclosure describes using particular privacy settings in a particular manner, this disclosure contemplates using any suitable privacy settings in any suitable manner.

In particular examples, the system 100, the external system 200, and the user devices 300A-300B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300A-300B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 100, the external system 200, and the user devices 300A-300B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300A-300B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300A-300B may access such information in order to provide a particular function or service to the first user, without the system 100, the external system 200, and the user devices 300A-300B having access to that information for any other purposes. Before accessing, storing, or using such objects or information, the system 100, the external system 200, and the user devices 300A-300B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300.

In particular examples, a user may specify whether particular types of objects or information associated with the first user may be accessed, stored, or used by the system 100, the external system 200, and the user devices 300. As an example and not by way of limitation, the first user may specify that images sent by the first user through the system 100, the external system 200, and the user devices 300A-300B may not be stored by the system 100, the external system 200, and the user devices 300. As another example and not by way of limitation, a first user may specify that messages sent from the first user to a particular second user may not be stored by the system 100, the external system 200, and the user devices 300. As yet another example and not by way of limitation, a first user may specify that all objects sent via a particular application may be saved by the system 100, the external system 200, and the user devices 300.

In particular examples, privacy settings may allow a first user to specify whether particular objects or information associated with the first user may be accessed from the system 100, the external system 200, and the user devices 300. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300A-300B may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300A-300B to provide recommendations for restaurants or other places in proximity to the user. The first user's default privacy settings may specify that the system 100, the external system 200, and the user devices 300A-300B may use location information provided from one of the user devices 300A-300B of the first user to provide the location-based services, but that the system 100, the external system 200, and the user devices 300A-300B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300A-300B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300A-300B may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300A-300B receiving the inputs necessary to determine the mood, emotion, or sentiment. As an example and not by way of limitation, the system 100, the external system 200, and the user devices 300A-300B may determine that a default privacy setting is to not receive any information necessary for determining mood, emotion, or sentiment until there is an express indication from a user that the system 100, the external system 200, and the user devices 300A-300B may do so. By contrast, if a user does not opt in to the system 100, the external system 200, and the user devices 300A-300B receiving these inputs (or affirmatively opts out of the system 100, the external system 200, and the user devices 300A-300B receiving these inputs), the system 100, the external system 200, and the user devices 300A-300B may be prevented from receiving, collecting, logging, or storing these inputs or any information associated with these inputs. In particular examples, the system 100, the external system 200, and the user devices 300A-300B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300A-300B may use the user's mood, emotion, or sentiment to provide newsfeed items, pages, friends, or advertisements to a user. The user may specify in their privacy settings that the system 100, the external system 200, and the user devices 300A-300B may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300A-300B may use his or her mood, emotion, or sentiment to provide newsfeed content and recommend pages, but not for recommending friends or advertisements. The system 100, the external system 200, and the user devices 300A-300B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300A-300B may be restricted in its access, storage, or use of the objects or information. The system 100, the external system 200, and the user devices 300A-300B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300A-300B may temporarily store the message in a content data store until the second user has viewed or downloaded the message, at which point the system 100, the external system 200, and the user devices 300A-300B may delete the message from the data store. As another example and not by way of limitation, continuing with the prior example, the message may be stored for a specified period of time (e.g., 2 weeks), after which point the system 100, the external system 200, and the user devices 300A-300B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300A-300B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300. The user's privacy settings may specify that such information may be used only for particular processes, such as authentication, and further specify that such information may not be shared with any external system or used for other processes or applications associated with the system 100, the external system 200, and the user devices 300. As another example and not by way of limitation, the system 100, the external system 200, and the user devices 300A-300B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300. As another example and not by way of limitation, the system 100, the external system 200, and the user devices 300A-300B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300A-300B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300A-300B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300A-300B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300A-300B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300A-300B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300A-300B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300A-300B may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300A-300B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor; and
a memory storing instructions, which when executed by the processor, cause the processor to:
access information associated with one or more events occurring on a computer-implemented platform having event activity;
log and analyze the one or more events to generate measurement data associated with the event activity;
generate a metric associated with the measurement data, wherein the memory storing instructions further cause the processor to:
structure an ownership of the metric based on at least one of a user or a setting associated with the metric;
specify a lifetime of use of the metric;
associate one or more types of meta-information to the metric related to origin, ownership, and application of the metric;
determine one or more computer-implemented protocols associated with the lifetime of use of the metric, the ownership, the application, modification, and computation of the metric; and
provide a customized implementation of the metric on a configurable measurement platform according to the lifetime of use of the metric, the one or more types of meta-information, and the one or more computer-implemented protocols;
enable an evaluation of suitability of the metric for a setting, circumstance, or use case, wherein the evaluation of suitability comprises a health check to indicate if the metric is trusted;
generate, based on the evaluation of suitability, a computed metric value associated with the metric utilizing the measurement data, comprising minimization of a blast radius associated with the metric;
implement a platform computation utilizing the computed metric value; and
implement a decision to modify an aspect of the computer-implemented platform based on the platform computation.

2. The system of claim 1, wherein to implement the platform computation, the instructions when executed by the processor further cause the processor to implement one or more computer-implemented models.

3. The system of claim 1, wherein the instructions when executed by the processor further cause the processor to enable processing measurement data associated with users that have exercised an opt-in option and not use measurement data associated with users that have not exercised the opt-in option, wherein the measurement data associated with users that have exercised an opt-in option and the measurement data associated with users that have not exercised the opt-in option are included in the measurement data.

4. The system of claim 1, wherein the instructions when executed by the processor further cause the processor to implement a recovery process upon determining the metric is unhealthy or incorrectly specified.

5. The system of claim 1, wherein the instructions when executed by the processor further cause the processor to provide status information associated with the metric.

6. The system of claim 5, wherein the status information comprises a classification of the metric.

7. The system of claim 1, wherein to generate the computed metric value, the instructions when executed by the processor further cause the processor to access and utilize associated auxiliary data.

8. A method for implementing a configurable measurement platform, comprising:
accessing information associated with one or more events occurring on a computer-implemented platform having event activity;
logging and analyzing the one or more events to generate measurement data associated with the event activity;
generating a metric associated with the measurement data, comprising:
structuring an ownership of the metric based on at least one of a user or a setting associated with the metric;
specifying a lifetime of use of the metric;
associating one or more types of meta-information to the metric related to origin, ownership, and application of the metric;
determining one or more computer-implemented protocols associated with the lifetime of use of the metric, the ownership, the application, modification, and computation of the metric; and
provide a customized implementation of the metric on a configurable measurement platform according to the lifetime of use of the metric, the one or more types of meta-information, and the one or more computer-implemented protocols;
enabling an evaluation of suitability of the metric for a setting, circumstance, or use case, wherein the evaluation of suitability comprises a health check to indicate if the metric is trusted;
generating, based on the evaluation of suitability, a computed metric value associated with the metric utilizing the measurement data, comprising minimizing of a blast radius associated with the metric;
implementing a platform computation utilizing the computed metric value; and
implementing a decision to modify an aspect of the computer-implemented platform based on the platform computation.

9. The method of claim 8, wherein the generating the metric associated with the measurement data comprises providing a first user authority to create the metric and not providing a second user authority to create the metric.

10. The method of claim 9, further comprising providing the second user authority to modify an aspect of the metric.

11. The method of claim 8, wherein the generating the metric comprises limiting one of a contextual use of the metric and a temporal use of the metric.

12. The method of claim 8, including associating various meta-information with the metric, the meta-information comprising information associated with one or more creators of the metric, information associated with previous use of the metric, and information associated with how the metric is to be applied.

13. The method of claim 8, wherein implementing the platform computation comprises implementing one or more computer-implemented models.

14. A non-transitory computer-readable storage medium having an executable stored thereon, which when executed instructs a processor to:
analyze one or more events occurring on a computer-implemented platform to generate measurement data;
generate a metric associated with the measurement data, wherein the executable further instructs the processor to:
structure an ownership of the metric based on at least one of a user or a setting associated with the metric;
specify a lifetime of use of the metric;
associate one or more types of meta-information to the metric related to origin, ownership, and application of the metric;
determine one or more computer-implemented protocols associated with the lifetime of use of the metric, the ownership, the application, modification, and computation of the metric; and
provide a customized implementation of the metric on a configurable measurement platform according to the lifetime of use of the metric, the one or more types of meta-information, and the one or more computer-implemented protocols;
enable an evaluation of suitability of the metric for a setting, circumstance, or use case, wherein the evaluation of suitability comprises a health check to indicate if the metric is trusted;
generate, based on the evaluation of suitability, a computed metric value associated with the metric utilizing the measurement data, comprising minimization of a blast radius associated with the metric; and
implement a platform computation to modify an aspect of the computer-implemented platform utilizing the computed metric value.

15. The non-transitory computer-readable storage medium of claim 14, wherein the executable when executed further instructs the processor to facilitate a decision associated with the computer-implemented platform based on the platform computation.

16. The non-transitory computer-readable storage medium of claim 14, wherein to analyze the one or more events, generate the metric, generate the computed metric value, and implement the platform computation, the executable when executed further instructs the processor to implement a domain-specific language (DSL) associated with a configurable measurement platform.

17. The non-transitory computer readable storage medium of claim 14, wherein the executable when executed further instructs the processor to implement a recovery process upon determining the metric is unhealthy or incorrectly specified.

18. The non-transitory computer-readable storage medium of claim 14, wherein the executable when executed further instructs the processor to provide status information associated with the metric.

19. The non-transitory computer-readable storage medium of claim 14, wherein implementing the platform computation, the executable when executed further instructs the processor to implement one or more computer-implemented models.

20. The non-transitory computer-readable storage medium of claim 14, wherein the computed metric value is a click-through rate (CTR).
